(19) United States
(12) Patent Application Publication
(10) Pub. No.: US 2023/0094402 A1
(43) Pub. Date: Mar. 30, 2023

(54) COMPOSITIONS CONTAINING ZIRCONIUM AND CERIUM AND METHODS FOR PREPARING SAME USING OXALIC ACID AND SUPERCRITICAL DRYING

(71) Applicant: Neo Performance Materials (Singapore) Pte. Ltd., Singapore (SG)

(72) Inventors: Barry HUANG, Singapore (SG); Perlyn KOH, Singapore (SG); Jesline TANG, Singapore (SG); Szu Hwee NG, Singapore (SG)

(73) Assignee: Neo Performance Materials (Singapore) Pte. Ltd., Singapore (SG)

(21) Appl. No.: 17/911,037

(22) PCT Filed: Feb. 19, 2021
(86) PCT No.: PCT/IB2021/000095

§ 371 Date: Sep. 12, 2022

Related U.S. Application Data
(60) Provisional application No. 62/990,420, filed on Mar. 16, 2020.

(51) Int. Cl. B01J 21/06; B01J 35/02; B01J 23/63; B01J 37/06

(52) U.S. Cl. CPC B01J 21/066; B01J 35/023; B01J 23/63; B01J 37/06

(57) ABSTRACT

Disclosed herein are compositions containing zirconium and cerium having a surprisingly small particle size. The compositions disclosed herein contain zirconium, cerium, optionally yttrium, and optionally one or more other rare earth oxides other than cerium and yttrium. The compositions exhibit a particle size characterized by a D₉₀ value of about 5 μm to about 30 μm and a D₉₉ value of about 5 um to about 40 um. Further disclosed are processes of producing these compositions using oxalic acid and supercritical drying in the process. The compositions can be used as a catalyst and/or part of a catalytic system. The composition is prepared by co-precipitation using oxalic acid and supercritical drying.

### INTRODUCTION

Cerium and zirconium oxide (CeO₂— ZrO₂) based materials have been used in catalytic applications. Introduction of zirconium into the cerium (IV) oxide lattice or cerium into the zirconium oxide lattice greatly enhances and facilitates oxygen mobility. This fact has been readily adapted by the automotive pollution control catalyst industry where cerium and zirconium oxide (CeO₂— ZrO₂) containing materials are ubiquitous in use as washcoat components. These materials catalyze oxidation of carbon monoxide and hydrocarbons and reduction of nitrogen oxides as shown in the below equations:

2CO+O₂→2CO₂

CₓH₂ₓ₊₂+[(3x+1)/2]O₂→xCO₂+(x+1)H₂O

2NO+2CO→2CO₂+N₂

Cerium and zirconium oxide (CeO₂— ZrO₂) based materials also have been used in catalytic applications as supports to disperse active metal catalysts so as to enhance the activity of the catalyst resulting in high turn-over numbers. To this, the support plays a major role in maintaining the active metal catalyst's high dispersion state even at severe operating conditions such as high temperatures and hydrothermal environments. A support that fails to maintain its structural integrity under severe conditions may result in the occlusion or sintering of the active catalyst metal sites which results in diminished activity of the catalyst on a per molecule basis. Since many of these catalysts utilize expensive precious metals, such as platinum, palladium and/or rhodium, loss of catalyst metal activity directly impacts the cost of such catalysts requiring the use of increased precious metal loadings in order to maintain the desired catalyst activity. Parallel to this, the use of a structurally stable support allows for reduced precious metal use whilst maintaining or improving catalyst activity.

These cerium and zirconium catalysts are useful in contributing to the lowering of harmful vehicle exhaust gases. They provide high surface areas and oxygen buffering capacity, which are useful in these applications. The materials contribute to the enhancement of a catalytic system's ability to lower the emissions of gases such as hydrocarbons, carbon monoxide, and nitrogen oxides.

In general, the catalytic material is required to have a sufficiently large specific surface area and a sufficiently high oxygen buffering capability, even at elevated temperatures.

A variety of synthesis methods for the production of the cerium and zirconium oxide (CeO₂— ZrO₂) based materials also have been reported.

It is an object of the present application to provide cerium and zirconium based materials with excellent catalyst characteristics useful in catalysis and processes for synthesizing these materials. That is, as a catalyst/catalyst support having a high surface area, a stable surface under oxidizing, reducing and hydrothermal and redox conditions, with stable crystallographic characteristics under severe aging conditions, high and stable mercury intrusion volume, with selective porosity/mercury intrusion volume, with high activity at lower temperatures and with low mass transfer resistance and high dynamic oxygen storage and release characteristics. A small particle size and a narrow particle size distribution are also desirable.

### SUMMARY

As disclosed herein, the present compositions comprise zirconium, cerium, optionally yttrium, and optionally one or more rare earths other than cerium and yttrium. These compositions have a small particle size characterized by a D₉₀ value of from about 5 μm to about 30 μm and a D₉₉ value of about 5 μm to about 40 μm. These compositions having small particle sizes also have narrow particle size distributions and further have desirable mercury intrusion volumes and surface areas.

In certain embodiments of the above-described compositions, the composition may also have a total mercury intrusion volume of from about 0.5 to about 4 cc/g after calcination at 1000 degrees Celsius for 10 hours in an oxidizing environment and a total mercury intrusion volume of from about 0.5 to about 3.0 cc/g after calcination at 1100 degrees Celsius for 10 hours in an oxidizing environment.

In other embodiments of the above-described compositions, the composition further may have a surface area of about 40 m²/g to about 100 m²/g after calcination at 1000 degrees Celsius for a period of 10 hours in an oxidizing environment and about 20 m²/g to about 85 m²/g after calcination at 1100 degrees Celsius for a period of 10 hours in an oxidizing environment.

Further disclosed herein is a process of producing a composition comprising zirconium, cerium, and optionally yttrium, and optionally one or more rare earths other than cerium and yttrium. The process comprises the steps of: (a) mixing aqueous oxalic acid, zirconium solution, cerium solution, optionally yttrium, and optionally one or more rare earth solutions other than cerium and yttrium to provide a mixture; (b) adding the mixture to a basic solution comprising lauric acid and diethylene glycol mono-n-butyl either to form a precipitate; (c) supercritically drying the precipitate; and (d) calcining the precipitate to provide a composition comprising zirconium, cerium, optionally yttrium, and optionally one or more rare earths other than cerium and yttrium. The process also can include the steps of washing the precipitate with water and dewatering with alcohol before supercritically drying. The process can include nixing rare earth solutions other than cerium and yttrium in step (a) to provide the mixture and further include mixing an yttrium solution in step (a) t provide the mixture. The compositions made by these processes have small particle sizes, narrow particle size distributions, and desirable mercury intrusion volumes and surface areas.

The disclosed compositions can be used in catalysts for purifying exhaust gases or catalyst supports to improve heat resistance and catalyst activity when used with precious metal. These disclosed cerium and zirconium oxide (CeO₂—ZrO₂) based materials possess high surface areas that have stable surfaces when subjected to severe aging conditions, such as under high temperature air, hydrothermal and redox conditions. They also possess stable crystallographic characteristics under severe aging conditions, high, stable, and selective mercury intrusion volumes, with high redox activities at lower temperatures and with low mass transfer resistance and high dynamic oxygen storage and release characteristics.

### BRIEF DESCRIPTION OF THE DRAWINGS

FIG. 1 illustrates a flowchart of an embodiment of the experimental process of making the cerium and zirconium containing compositions using aqueous oxalic acid and supercritical drying, as disclosed herein.

FIG. 2 is a graph showing the as-made particle size distribution of a composition containing Ce/Zr/La/Nd elemental components made by a process as disclosed herein using oxalic acid and supercritically drying in comparison to a composition containing Ce/Zr/La/Nd made by the process, but not including the use of oxalic acid. All ratios are on a weight oxide equivalent basis.

FIG. 3 is a graph showing the as-made particle size distribution of a composition containing Ce/Zr/La/Nd/Pr elemental components made by a process as disclosed herein using oxalic acid and supercritical drying in comparison to a composition containing Ce/Zr/La/Nd/Pr made by the process, but not including the use of oxalic acid. All ratios are on a weight oxide equivalent basis.

FIG. 4 is a graph showing the as-made particle size distribution of a composition containing Ce/Zr/La/Pr elemental components made by a process as disclosed herein using oxalic acid and supercritical drying in comparison to a composition containing Ce/Zr/La/Pr made by the process, but not including the use of oxalic acid. All ratios are on a weight oxide equivalent basis.

FIGS. 5A-5C are graphs showing the difference in oxidizing environment aged surface areas of various compositions containing cerium and zirconium made by a comparative process not using aqueous oxalic acid or heating in comparison with various compositions containing cerium and zirconium made by processes using aqueous oxalic acid and supercritical drying as disclosed herein. FIG. 5A includes graphs for Ce/Zr/La/Nd with a ratio of 20.8/72.2/1.7/5.3. FIG. 5B includes graphs for Ce/Zr/La/Nd/Pr with a ratio of 40/50/2/4/4. FIG. 5C includes graphs for Ce/Zr/La/Pr with a ratio of 40/50/5/5. All ratios are on a weight oxide equivalent basis.

FIGS. 6A-6C are graphs showing the difference in oxidizing environment aged material total mercury intrusion volumes of various compositions containing cerium and zirconium made by a comparative process not using aqueous oxalic acid or heating in comparison various compositions containing cerium and zirconium made by processes using aqueous oxalic acid and supercritical drying as disclosed herein. FIG. 6A includes graphs for Ce/Zr/La/Nd with a ratio of 20.8/72.2/1.7/5.3. FIG. 6B includes graphs for Ce/Zr/La/Nd/Pr with a ratio of 40/50/2/4/4. FIG. 6C includes graphs for Ce/Zr/La/Pr with a ratio of 40/50/5/5. All ratios are on a weight oxide equivalent basis.

FIGS. 7A and 7B are graphs showing the typical mercury intrusion volume of various compositions containing cerium and zirconium made by a comparative process not using aqueous oxalic acid or heating in comparison to various compositions containing cerium and zirconium made by processes using aqueous oxalic acid and supercritical drying as disclosed herein.

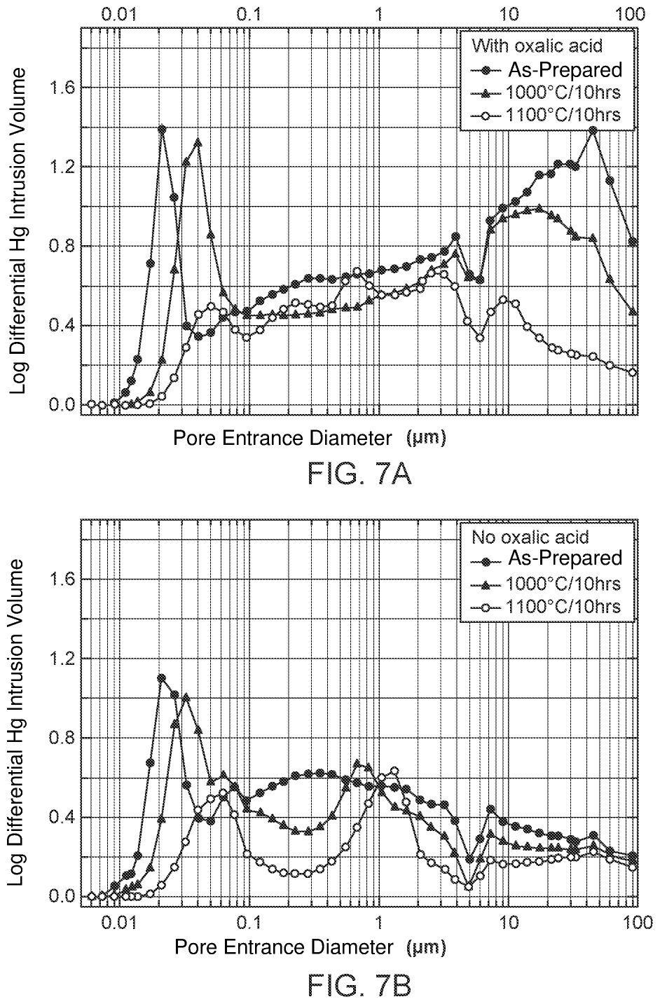

### DETAILED DESCRIPTION

Before the compositions having small particle sizes, narrow particle size distributions, and desirable mercury intrusion volumes and surface areas and processes are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present application relates to compositions having small particle sizes, narrow particle size distributions, and desirable mercury intrusion volumes and surface areas. The present application further relates to processes for making these compositions. The compositions disclosed herein contain zirconium, cerium, optionally yttrium optionally one or more rare earths other than cerium and yttrium. These compositions have advantageous properties for use in catalysis as a catalyst and/or as part of a catalyst system.

As disclosed herein, the compositions comprise zirconium, cerium, optionally yttrium, and optionally one or more other rare earths other than cerium and yttrium.

In one embodiment, the compositions further comprise one or more other rare earths selected from lanthanum, praseodymium, neodymium, or mixtures thereof. In additional embodiments of any of the above compositions, the compositions further comprise yttrium.

These compositions have a particle size characterized by a D₉₀ value of about 5 μm to about 30 μm and a D₉₉ value of about 5 μm to 40 μm. In some embodiments, these compositions have a particle size characterized by a D₉₀ value of about 5 μm to about 20 μm, or about 5 μm to about 15 μm, and a D₉₉ value of about 5 μm to about 30 μm, or about 5 μm to about 25 μm. In some of these embodiments as defined above, the compositions have a D₅₀ value of about 1 μm to about 10 μm, and in certain embodiments about 1 μm to about 5 μm. In certain of these embodiments, the compositions have a D₁₀ value of about 0.5 μm to about 2.5 μm, and in certain embodiments about 0.5 μm to about 2 μm.

In some embodiments, these compositions have a particle size characterized by a D₉₀ value of from about 5 μm to about 20 μm and a D₉₉ value of about 5 μm to about 30 μm. In some of these embodiments, the compositions further have a D₅₀ value of from about 1 μm to about 5 μm. In certain of these embodiments, the compositions have a D₁₀ value of about 0.5 μm to about 2 μm.

In other embodiments, these compositions have a particle size characterized by a D₉₀ value of from about 10 μm to about 15 μm and a D₉₉ value of about 10 μm to about 30 μm. In some of these embodiments, the compositions further have a D₅₀ value of from about 1 μm to about 3 μm. In certain of these embodiments, the compositions have a D₁₀ value of about 1 μm to about 2.5 μm.

In particular embodiments, the compositions are characterized by a D₉₀ value of about 10 μm to about 15 μm, a D₉₉ value of about 10 μm to about 30 μm, a D₅₀ value of about 1 μm to about 3 μm, and a D₁₀ value of about 1 μm to about 2.5 μm.

In particular embodiments, the compositions are characterized by a D₉₉ value of about 5 μm to about 15 μm, a D₉₀ value of about 5 μm to about 8 μm, a D₅₀ value of about 2 μm to about 3 μm, and a D₁₀ value of about 1 μm to about 2 μm.

In particular embodiments, the compositions are further characterized by a D₂₅ value of about 1 μm to about 3 μm and a D₇₅ value of about 3 μm to about 8 μm.

In particular embodiments, the compositions are characterized by a D₉₉ value of about 22 μm, a D₉₀ value of about 11 μm, a D₅₀ value of about 4 μm, and a D₁₀ value of about 2 μm. In this embodiment, the compositions may further be characterized by a D₂₅ value of about 3 μm and a D₇₅ value of about 6.5 μm.

In other particular embodiments, the compositions are characterized by a D₉₉ value of about 11 μm, a D₉₀ value of about 5 μm, a D₅₀ value of about 2.5 μm, and a D₁₀ value of about 1 μm. In this embodiment, the compositions may further be characterized by a D₂₅ value of about 1.5 μm and a D₇₅ value of about 3.5 μm.

In another particular embodiment, the compositions are characterized by a D₉₉ value of about 31 μm, a D₉₀ value of about 12.5 μm, a D₅₀ value of about 4.5 μm, and a D₁₀ value of about 1.5 μm. In these particular embodiments, the compositions further may be characterized by a D₂₅ value of about 3 μm, a D₇₅ value of about 8 μm.

In some embodiments the compositions as disclosed herein may exhibit a percent reduction in D₅₀ of ≥20% in comparison to similar compositions made according to a similar process not utilizing oxalic acid and a percent reduction in D₉₀ of ≥25% in comparison to similar compositions made according to a similar process not utilizing oxalic acid. In particular embodiments the compositions as disclosed herein may exhibit a percent reduction in D₅₀ of ≥40% in comparison to similar compositions made according to a similar process not utilizing oxalic acid and a percent reduction in D₉₀ of ≥50% in comparison to similar compositions made according to a similar process not utilizing oxalic acid.

Particle size analysis was done using a Microtrac S3500 particle size analyzer. A typical measurement is done by using approximately 0.2 grams of a powder sample, 20 ml of a 2% sodium hexametaphosphate solution is added to the sample. The sample+solution are then sonicated for approximately 3 minutes. A few drops of the sonicated solution are then added to the sample container of the instrument. The sample is again sonicated in the machine for another 3 minutes. Three consecutive runs are done by the machine according to the instrument manufacturer instruction manual. The three runs are averaged and the results recorded.

With regard to a narrow particle size distribution, the particle size distribution as defined herein is (D₉₀-D₁₀)/D₅₀. As such, a narrow particle size distribution as used herein means a (D₉₀-D₁₀)/D₅₀ of less than about 5. In certain embodiments, the particle size distribution may be less than about 3. In some embodiments the compositions as disclosed herein may exhibit a narrow particle size distribution that is measurably less than the particle size distribution of similar compositions made according to a similar process not utilizing oxalic acid and supercritical drying. In certain embodiments the compositions as disclosed herein may exhibit a narrow particle size distribution that is less than about half (about 50% smaller) than the particle size distribution of similar compositions made according to a similar process not utilizing oxalic acid and supercritical drying.

The compositions as disclosed herein having a small particle size also may exhibit a total mercury intrusion volume of from about 0.5 to about 4.0 cc/g after calcination at 1000 degrees Celsius for 10 hours in an oxidizing environment and in certain embodiments a total mercury intrusion volume of from about 0.5 to about 3.5 cc/g after calcination at 1000 degrees Celsius for 10 hours in an oxidizing environment. The compositions having a small particle size also may exhibit a total mercury intrusion volume of from about 0.5 to about 3.0 cc/g after calcination at 1100 degrees Celsius for 10 hours in an oxidizing environment and in certain embodiments a total mercury intrusion volume of from about 0.5 to about 2.0 cc/g after calcination at 1100 degrees Celsius for 10 hours in an oxidizing environment.

In particular embodiments, the compositions as disclosed herein having a small particle size also may exhibit a total mercury intrusion volume of from about 2.2 to about 3.0 cc/g after calcination at 1000 degrees Celsius for 10 hours in an oxidizing environment and a total mercury intrusion volume of from about 1.4 to about 2.0 cc/g after calcination at 1100 degrees Celsius for 10 hours in an oxidizing environment.

In other embodiments, the compositions as disclosed herein having a small particle size also may exhibit a total mercury intrusion volume of about 2.0 to about 3.2 cc/g after calcination at 1000 degrees Celsius for 10 hours in an oxidizing environment and a total mercury intrusion volume of about 1.25 to about 2.5 cc/g after calcination at 1100 degrees Celsius for 10 hours in an oxidizing environment. In certain embodiments, the compositions may exhibit a total mercury intrusion volume of about 2.2 to about 3.0 cc/g after calcination at 1000 degrees Celsius for 10 hours in an oxidizing environment and a total mercury intrusion volume of about 1.4 to about 2.0 cc/g after calcination at 1100 degrees Celsius for 10 hours in an oxidizing environment.

These mercury intrusion values after calcination at 1000 degrees Celsius for 10 hours in an oxidizing environment are increased by approximately 25% to 85% in comparison to cerium and zirconium containing oxides made by a comparative process not using aqueous oxalic acid and supercritical drying. These mercury intrusion values after calcination at 1100 degrees Celsius for 10 hours in an oxidizing environment are increased by approximately 20% to 85% in comparison to cerium and zirconium containing oxides made by a comparative process not using aqueous oxalic acid and supercritical drying.

The mercury intrusion volume was determined by using a Micromeritics Auto Pore IV mercury porosimeter using the following procedure. A powder sample was accurately weighed to 4 significant figures. It was then evacuated to 50 μm Hg in the machine sample holder. It was then subjected to mercury pressure (by the machine) with a filling pressure step of 0.5 psia. The dwell time at each step was 10 seconds. For the required conversion of pressure to pore entrance diameter, the value for mercury surface tension used was 485 dynes/cm and the contact angle used was 130°. The mercury intrusion volume was the integral of mercury intrusion volume into the sample at each pressure step.

The compositions as disclosed herein having small particle sizes further may exhibit a surface area of about 40 m²/g to about 100 m²/g after calcination at 1000 degrees Celsius for a period of 10 hours in an oxidizing environment and in certain embodiments a surface area of about 40 m²/g to about 75 m²/g after calcination at 1000 degrees Celsius for a period of 10 hours in an oxidizing environment and in other embodiments a surface area of about 40 m²/g to about 65 m²/g after calcination at 1000 degrees Celsius for a period of 10 hours in an oxidizing environment.

The compositions as disclosed herein having small particle sizes further may exhibit a surface area of about 20 m²/g to about 85 m²/g after calcination at 1100 degrees Celsius for a period of 10 hours in an oxidizing environment and in certain embodiments a surface area of about 20 m²/g to about 50 m²/g after calcination at 1100 degrees Celsius for a period of 10 hours in an oxidizing environment.

In particular embodiments, the compositions as disclosed herein having a small particle size further may exhibit a surface area of about 45 m²/g to about 65 m²/g after calcination at 1000 degrees Celsius for a period of 10 hours in an oxidizing environment and about 20 m²/g to about 30 m²/g after calcination at 1100 degrees Celsius for a period of 10 hours in an oxidizing environment.

The apparent surface area of the compositions was determined by using a Micromeritics ASAP 2000 system and nitrogen at about 77 Kelvin. The procedure outlined in ASTM International test method D 3663-03 (Reapproved 2008) was used but with one significant exception. It is well known that a “BET Surface Area” determination is not possible for materials that contain microporosity. Recognizing that the surface area is an approximation, the values reported are labeled “apparent surface area” values rather than “BET surface area” values. In compliance with commonly accepted procedures, the determination of apparent surface area, the application of the BET equation was limited to the pressure range where the term na(1-P/Po) of the equation continuously increases with P/Po. The out gassing of the sample was done under nitrogen at about 300 degrees Celsius for about 2 hours.

The mercury intrusion volume is associated with porosity and pore structure of catalyst/catalyst supports comprising cerium and zirconium. Regardless of the catalyst site activity, facile molecular transport of reactants to the active site and transport of reaction products away from the active site making it available for further reaction is of great importance. In situations where catalyst selectivity is of no consideration, a wide and open pore structure of the support is desirable. In situations where selectivity of the reacting molecules or products is desired, an engineered porosity allowing only the desired reactants to reach the active site and only the desired products allowed to leave the active site, is needed. For example, this type of function is well known and utilized with zeolitic materials. Therefore, materials with a particular mercury intrusion volume are beneficial depending on the types of desired reactions.

Particle size of catalytic material may directly affect the composition's surface area per unit volume/mass and hence number for active sites for catalytic conversion. Generally, surface area per unit volume/mass (specific surface area) increase as particle size decreases. Small particle size may also allow more catalytic cerium and zirconium oxide material to be used in washcoat components without blocking the channels of the monolith in catalytic converter. In this way, the catalytic converter tends to have higher performance while minimizing exhaust backpressure caused by blockages in monolith.

In the compositions as disclosed and described herein the above-recited particle sizes may be combined with any of the above recited mercury intrusion volumes after calcination at 1000 and 1100 degrees Celsius for 10 hours in an oxidizing environment in any combination and further may be combined in any combination with the above-recited surface areas after calcination at 1000 and 1100 degrees Celsius for a period of 10 hours in an oxidizing environment in any combination. The above-recited mercury intrusion volumes after calcination at 1000 and 1100 degrees Celsius for 10 hours in an oxidizing environment may be combined in any combination and further may be combined in any combination with the above-recited surface areas after calcination at 1000 and 1100 degrees Celsius for a period of 10 hours in an oxidizing environment. The above-recited surface areas after calcination at 1000 and 1100 degrees Celsius for 10 hours in an oxidizing environment may be combined in any combination and further may be combined in any combination with the above-recited mercury intrusion volumes after calcination at 1000 and 1100 degrees Celsius for a period of 10 hours in an oxidizing environment.

In these compositions, the molecular ratio of Zr/Ce is greater than 50%. The ratio of Zr to Ce (Zr:Ce) in the composition is about 1:1 to about 4:1, and in certain embodiments about 1:1 to about 2:1. In certain embodiments of these compositions, any additional components (e.g., yttrium, and rare earths other than cerium) are present in an amount of 0 to 30% weight oxide based.

In certain compositions, the ratio of CeO₂/ZrO₂ can be approximately 15-60 wt %/40-75 wt %. All compositions are referenced on an oxide equivalent basis.

In particular embodiments of the compositions, the ratio of CeO₂/ZrO₂/La₂O₃/Nd₂O₃ can be approximately 18-55 wt %/40-75 wt %/1-8 wt %/1-8 wt %. In one example embodiment of these compositions, the ratio of CeO₂/ZrO₂/La₂O₃/Nd₂O₃ can be approximately 20.8 wt %/72.2 wt %/1.7 wt %/5.3 wt %. All compositions are referenced on an oxide equivalent basis.

In other embodiments, the ratio of CeO₂/ZrO₂/La₂O₃/Y₂O₃ can be approximately 20-55 wt %/40-75 wt %/1-8 wt %/1-8 wt %. In one example embodiment of these compositions, the ratio of CeO₂/ZrO₂/La₂O₃/Y₂O₃ can be approximately 45 wt %/45 wt %/5 wt %/5 wt %.

In further embodiments of these compositions, the ratio of CeO₂/ZrO₂/La₂O₃/Nd₂O₃/Pr₆O₁₁ can be approximately 30-55 wt %/40-75 wt %/1-8 wt %/1-8 wt %/1-8 wt %. In certain of these compositions, the ratio of CeO₂/ZrO₂/La₂O₃/Nd₂O₃/Pr₆O₁₁ can be approximately 40/50/2/4/4. All compositions are referenced on an oxide equivalent basis.

In other embodiments, the ratio of CeO₂/ZrO₂/La₂O₃/Pr₆O₁₁ can be approximately 30-55 wt %/40-75 wt %/1-8 wt %/1-8 wt %. In one example embodiment of these compositions, the ratio of CeO₂/ZrO₂/La₂O₃/Pr₆O₁₁ can be approximately 40 wt %/50 wt %/5 wt %/5 wt %.

The compositions as disclosed herein are made by a process comprising: (a) mixing aqueous oxalic acid, zirconium solution, cerium solution, optionally yttrium, and optionally one or more rare earth solutions other than cerium and yttrium to provide a mixture; (b) adding the mixture to a basic solution containing lauric acid and diethylene glycol mono-n-butyl ether to form a precipitate; (c) supercritically drying the precipitate; and (d) calcining the precipitate to provide a composition comprising zirconium, cerium, optionally yttrium, and optionally one or more other rare earths other than cerium and yttrium.

As such, step (a) of the process further can include mixing rare earth solutions other than cerium and yttrium to provide the mixture. These rare earths include, for example, lanthanum, praseodymium, neodymium, or mixtures thereof. Step (a) additionally can include mixing a yttrium solution to provide the mixture.

The zirconium, cerium, optionally yttrium, and optionally other rare earth solutions can be made from any soluble salt form of these elements. The starting rare earth salts are water soluble and in the process as disclosed herein can be dissolved in water. The rare earth salts can be nitrates, chlorides, and the like. The cerium salt can be of Ce(III) or Ce(IV) oxidation state.

Preferably, the oxalic acid is first combined with the zirconium and cerium solutions, and optional other rare earth solutions and yttrium solution. This mixture is then added to the basic solution which also contains lauric acid and diethylene glycol mono-n-butyl ether solution. The rate of reactant addition is not critical.

The process can also include the step of dewatering with an alcohol prior to supercritical drying. The alcohol can be any suitable alcohol, including for example, isopropanol, ethanol, methanol, and the like.

Compositions made by this process can have a particle size characterized by a D₉₀ values and D₉₉ values as set forth above. Compositions made by this process also may exhibit a narrow particle size distribution as set forth above. It is important to note that these small particle sizes are achieved without an active comminution step. As described above, small particle size may lead to larger specific surface and higher number of active sites. Also, more catalytic material may be used without generating further exhaust backpressure when the compositions exhibit small particle sizes. Furthermore, production effort and cost may be reduced significantly if well controlled small particle sized cerium and zirconium oxide (CeO₂—ZrO₂) based materials are obtained as-produced without an additional comminution step.

Addition of oxalic acid and the step of supercritical drying in the process are distinguishing features of the process and with this addition and supercritical drying, compositions having a surprisingly small particle size and narrow particle size distribution are obtained, even without micronization. In the processes as disclosed herein, the oxalic acid can be added in an amount of approximately 25-100% by weight with respect to equivalent oxide basis.

Further, in the process disclosed herein, the base concentration of the basic solution can be approximately 3N to 6 N, and in one embodiment approximately 4.5 N. The basic solution can be ammonia, ammonium hydroxide, sodium hydroxide, and the like. The basic solution contains lauric acid and diethylene glycol mono-n-butyl ether.

The lauric acid can be added in an amount of approximately 50-200% of the oxide equivalent on a weight basis. The diethylene glycol mono-n-butyl ether can be added in an amount of approximately 50-150% of the oxide equivalent on a weight basis.

In the process as disclosed herein, supercritical drying is utilized. The supercritical drying can be conducted at approximately 250-350° C. and approximately 130-140 bar.

The process further can include the step of washing the precipitate with water before calcining. The precipitate may be washed with water to achieve a selected conductivity before calcining. In some embodiments this desired conductivity is 6-8 mS/cm.

The precipitates can be separated from the liquid by decantation, vacuum filtration or a combination of both or any other suitable method.

In the process as disclosed herein, the calcining can conducted at a temperature ranging from about 400° C. to 1100° C. and for from about 0.25 to 24 hours, and in certain embodiments, calcining can conducted at a temperature ranging from about 800° C. to 1000° C. and for from about 3 to 7 hours. In particular embodiments, calcining can be conducted at a temperature of about 900° C. and for about 5 hours. The temperature and time of calcination should be sufficient to remove the non-rare earth and non-zirconium materials and also to ensure that the oxide is obtained.

Calcining can be conducted in any appropriate furnace and environment including but not limited to oxidizing, reducing, hydrothermal, or inert or combinations thereof. In some embodiments, an oxidizing environment is preferred. A tubular furnace can be used. By virtue of its tubular design, a tube furnace allows better gas flow for more thorough treatment. The calcining process provides the composition as disclosed herein.

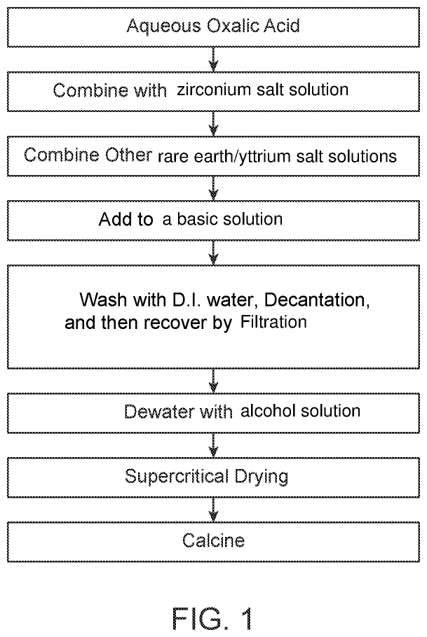

FIG. 1 is a flow chart for an embodiment of the process of making the compositions as disclosed herein.

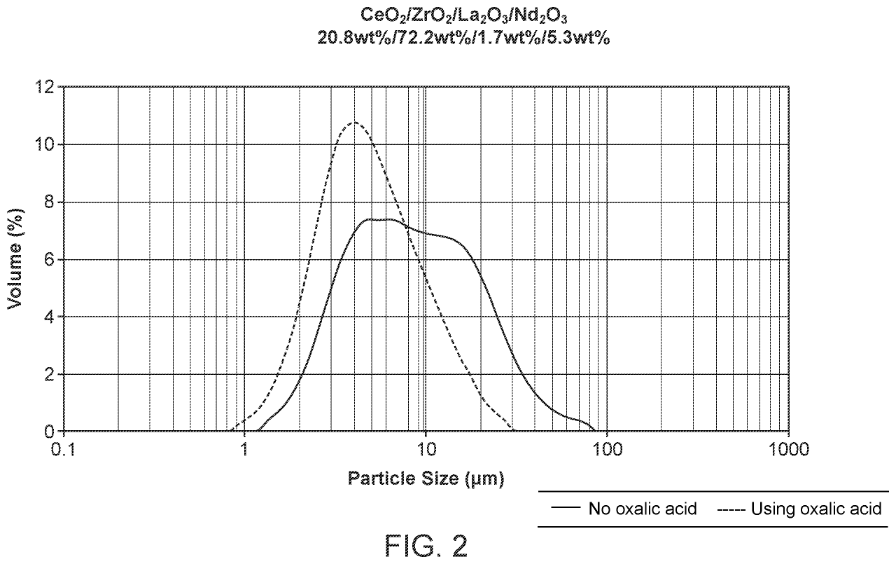

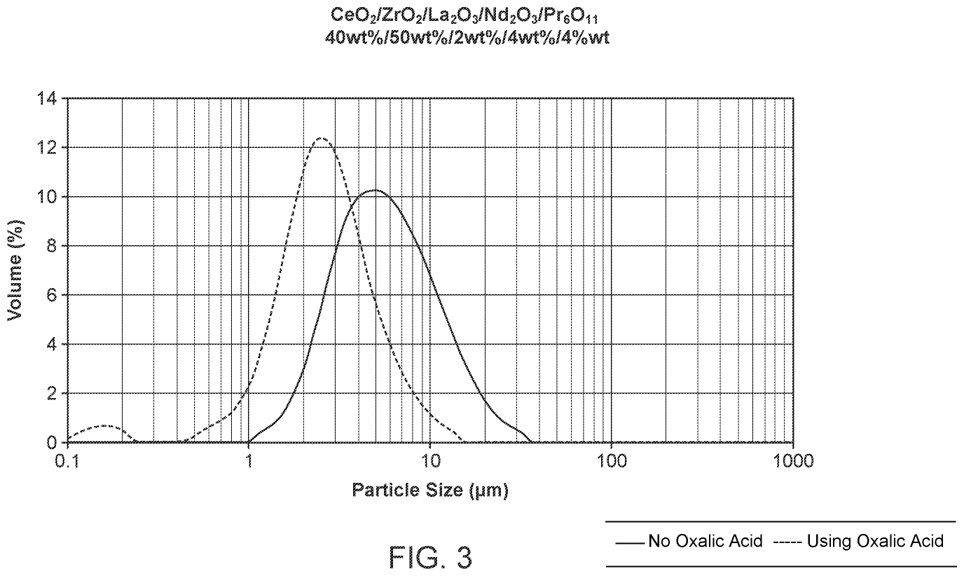

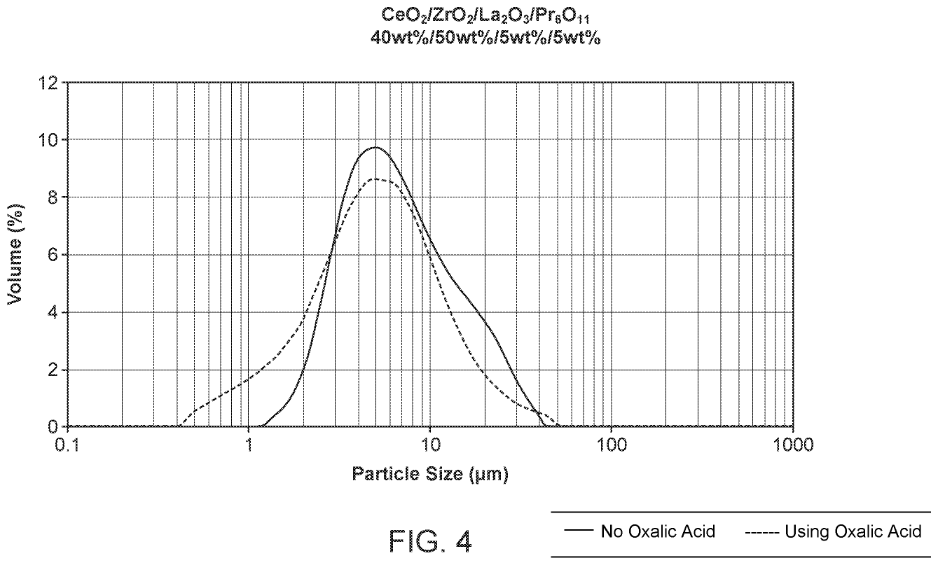

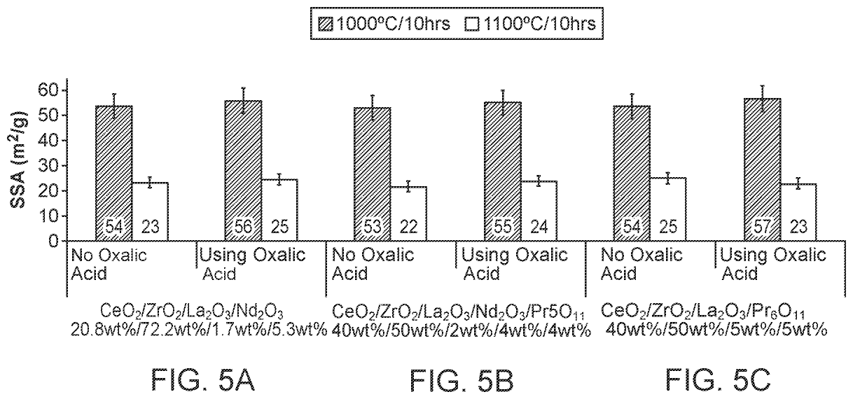

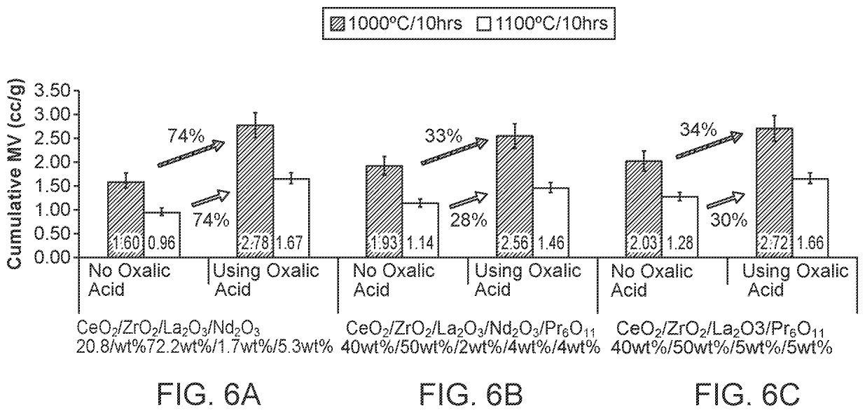

The compositions as disclosed herein were made and tested for particle size, mercury intrusion volume, and surface areas and compared to similar compositions made according to a similar process not utilizing oxalic acid and supercritical drying. The compositions as disclosed herein and made by the processes disclosed herein exhibit a surprisingly small particle size (FIGS. 2, 3, and 4), good mercury intrusion volume (FIGS. 6A-6C), and similar surface area (FIGS. 5A-5C).

The compositions as disclosed herein and made by the processes disclosed herein also may exhibit surprisingly narrow particle size distributions in compositions to similar compositions made according to a similar process not utilizing oxalic acid and supercritical drying. As such, in some embodiments the compositions as disclosed herein may exhibit a particle size distribution that is less than the particle size distribution of similar compositions made according to a similar process not utilizing oxalic acid and supercritical drying.

In the following, Examples are given to illustrate the inventive method for the preparation of compositions comprising zirconium, cerium, optionally yttrium, optionally one or more other rare earths other than cerium and yttrium and characterization thereof in more detail, although the scope of the invention is never limited thereby in any way.

### Examples

### Example 1: Synthesis of CeO₂/ZrO₂/La₂O₃/Nd₂O₃(20.8 wt %/72.2 wt %/1.7 wt %/5.3 wt %)

The following was done in accordance with the steps as illustrated in FIG. 1:
1) An aqueous oxalic acid solution was prepared (50 wt % on a metal oxide equivalent basis).
2) A zirconyl nitrate solution was prepared with approximately 300 g/L on an equivalent ZrO₂ basis.
3) A solution of Ce/La/Nd nitrates was prepared (100 g/L on an equivalent oxide basis). Ceric ammonium nitrate was used as the cerium salt.
4) An aqueous ammonia hydroxide solution was prepared (NH₄OH=4.5M, NH₄OH/M+=10.1).
5) A precipitate was formed by adding the zirconium and rare earth nitrates solutions Ce/Zr/La/Nd to the NH₄OH solution.
6) The resultant wetcake (precipitate) was washed with deionized water to achieve a conductivity of 6-8 mS/cm and separated from the liquid by decantation and then by vacuum filtration.
7) The wetcake was dewatered by washing with ethanol.
8) The wetcake was subjected to supercritical drying at 300° C. and 130-140 bar.
9) The solids/precipitates were calcined at 900° C. for five hours.

### Example 2: Synthesis of CeO₂/ZrO₂/La₂O₃/Nd₂O₃/Pr₆O₁₁(40 wt %/50 wt %/2 wt %/4 wt %/4 wt %)

The procedures of Example 1 were followed, with the exception that the zirconium and rare earth ratios were varied to obtain the component ratios of this Example as defined above.

### Example 3: Synthesis of CeO₂/ZrO₂/La₂O₃/Pr₆O₁₁(40 wt %/50 wt %/5 wt %/5 wt %)

The procedures of Example 1 were followed, with the exception that the zirconium and rare earth ratios were varied to obtain the component ratios of this Example as defined above.

### Example 4: Comparative Example Synthesis of CeO₂/ZrO₂/La₂O₃/Nd₂O₃(20.8 wt %/72.2 Wt %/1.7 wt %/5.3 wt %)

The following was done:
1) A zirconyl nitrate solution was prepared with 300 g/L on an equivalent ZrO₂ basis.
2) A solution of Ce/La/Nd nitrates was prepared (100 g/L on an equivalent oxide basis). Ceric ammonium nitrate was used as the cerium salt.
3) An aqueous ammonia hydroxide solution was prepared (NH₄OH═4.5M, NH₄OH/M*=10.1).
4) A precipitate was formed by adding the zirconium and rare earth nitrates solutions Ce/Zr/La/Nd to the NH₄OH solution.
5) The resultant wetcake (precipitate) was washed with deionized water to achieve a conductivity of 6-8 mS/cm and separated from the liquid by decantation and then by vacuum filtration.
6) The wetcake was dewatered by washing with ethanol.
7) The wetcake was subjected to supercritical drying at 300° C. and 130-140 bar.
8) The solids/precipitates were calcined at 900° C. for five hours.

### Example 5: Comparative Example Synthesis of CeO₂/ZrO₂/La₂O₃/Nd₂O₃/Pr₆O₁₁(40 Wt %/50 wt %/2 wt %/4 wt %/4 wt %)

The procedures of Comparative Example 4 were followed, with the exception that the zirconium and rare earth ratios were varied to obtain the component ratios of this Example as defined above.

### Example 6: Comparative Example Synthesis of CeO₂/ZrO₂/La₂O₃/Pr₆O₁₁(40 wt %/50 wt %/5 wt %/5 wt %)

The procedures of Comparative Example 4 were followed, with the exception that the zirconium and rare earth ratios were varied to obtain the component ratios of this Example as defined above.

### Example 7: Incorporating CeO₂/ZrO₂/La₂O₃/Nd₂O₃(20.8 wt %/72.2 wt %/1.7 wt %/5.3 Wt %) Composition of Example into a Catalyst or Catalyst Support

The mixed oxide materials comprising cerium and zirconium as described herein can be utilized as major components in a catalyst or catalyst support to be incorporated into automobile exhaust system. Introduction of zirconium into the cerium (IV) oxide lattice or cerium into the zirconium oxide lattice greatly enhances and facilitates oxygen mobility. Also, doping these cerium and zirconium oxide (CeO₂— ZrO₂) solid solution with other rare earths such as La, Nd, Pr and Y further improves catalytic activity and heat resistance. These mixed oxide materials as disclosed herein possess high surface areas that are thermally stable when subjected to severe aging conditions such as under high temperature air, hydrothermal and redox conditions. They also possess stable crystallographic characteristics under severe aging conditions, high and stable porosity with high and selective mercury intrusion volumes, with high redox activity at lower temperatures and with low mass transfer resistance and high dynamic oxygen storage and release characteristics.

To make the catalyst or catalyst support, these cerium and zirconium mixed oxide powder is mixed with a refractory inorganic oxide, such as aluminium oxide, silicon oxide or titanium oxide, in water to form a powder slurry. Subsequently, precious metals, such as palladium, rhodium or platinum, and other additives, such as stabilizers, promoters and binders are added to the oxide slurry to obtain a washcoat. This washcoat slurry may then be coated onto a carrier, such as a ceramic monolithic honeycomb structure to prepare a catalyst for automobile exhaust gas purification.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A composition comprising zirconium, cerium and optionally one or more other rare earths other than cerium and optionally yttrium, having a particle size characterized by a D₉₀ value of about 5 μm to about 30 μm and a D₉₉ value of about 5 μm to about 40 μm.

2. The composition of claim 1, having a particle size characterized by a D₉₀ value of about 5 μm to about 20 μm and a D₉₉ value of about 5 μm to about 30 μm.

3. The composition of claim 1, having a particle size characterized by a D₉₀ value of about 5 μm to about 15 μm and a D₉₉ value of about 5 μm to about 25 μm.

4. The composition of claim 1, having a D₅₀ value of from about 1 μm to about 10 μm.

5. The composition of claim 4, having a D₅₀ value of from about 1 μm to about 5 μm.

6. The composition of claim 1, having a D₁₀ value of about 0.5 μm to about 2.5 μm.

7. The composition of claim 1, having a D₉₀ value of about 10 μm to about 15 μm, a D₉₉ value of about 10 μm to about 30 μm, a D₅₀ value of about 1 μm to about 3 μm, and a D₁₀ value of about 1 μm to about 2.5 μm.

8. The composition of claim 1, having a D₉₉ value of about 5 μm to about 15 μm, a D₉₀ value of about 5 μm to about 8 μm, a D₅₀ value of about 2 μm to about 3 μm, and a D₁₀ value of about 1 μm to about 2 μm.

9. The composition of claim 1, wherein the composition comprises one or more other rare earths wherein the other rare earths are selected from the group consisting of lanthanum, praseodymium, neodymium, or mixtures thereof.

10. The composition of any one of claim 9, wherein the composition comprises yttrium.

11. The composition of any one of claim 1, having a total mercury intrusion volume of from about 0.5 to about 4 cc/g after calcination at 1000 degrees Celsius for 10 hours in an oxidizing environment and a total mercury intrusion volume of from about 0.5 to about 3.0 cc/g after calcination at 1100 degrees Celsius for 10 hours in an oxidizing environment.

12. The composition of claim 12, having a total mercury intrusion volume of from about 0.5 to about 3.5 cc/g after calcination at 1000 degrees Celsius for 10 hours in an oxidizing environment and a total mercury intrusion volume of from about 0.5 to about 2.0 cc/g after calcination at 1100 degrees Celsius for 10 hours in an oxidizing environment.

13. (canceled)

14. The composition of claim 1, wherein the composition has a total mercury intrusion after calcination at 1000 degrees Celsius for 10 hours in an oxidizing environment volume that is increased by approximately 25% to 85% in comparison to cerium and zirconium containing oxides made by a comparative process not using aqueous oxalic acid.

15. (canceled)

16. The composition of claim 1, having a surface area of about 40 m²/g to about 100 m²/g after calcination at 1000 degrees Celsius for a period of 10 hours in an oxidizing environment and about 20 m²/g to about 85 m²/g after calcination at 1100 degrees Celsius for a period of 10 hours in an oxidizing environment.

17. The composition of claim 16, having a surface area of about 40 m²/g to about 75 m²/g after calcination at 1000 degrees Celsius for a period of 10 hours in an oxidizing environment and about 20 m²/g to about 50 m²/g after calcination at 1100 degrees Celsius for a period of 10 hours in an oxidizing environment.

18. (canceled)

19. (canceled)

20. A process of producing a composition comprising zirconium, cerium, optionally yttrium, optionally one or more other rare earths other than cerium and yttrium, comprising the steps of:
(a) mixing aqueous oxalic acid, zirconium solution, cerium solution, optionally yttrium, and optionally one or more rare earth solutions other than cerium and yttrium to provide a mixture;
(b) adding the mixture to a basic solution to form a precipitate;
(c) supercritically drying the precipitate; and
(d) calcining the precipitate to provide a composition comprising zirconium, cerium, optionally yttrium, and optionally one or more rare earths other than cerium and yttrium.

21. The process of claim 20, wherein in step (a) aqueous oxalic acid, zirconium solution, cerium solution, and one or more rare earth solutions selected from the group consisting of lanthanum, praseodymium, neodymium, and mixtures thereof are mixed to provide the mixture.

22. The process of claim 20, wherein in step (a) a yttrium solution is mixed to provide the mixture.

23. The process of claim 20 further comprising washing the precipitate with water prior to supercritical drying.

24. The process of claim 20, further comprising dewatering with an alcohol prior to supercritical drying.

25. (canceled)

26. The process of claim 20, wherein the oxalic acid is added in an amount of approximately 25-100% by weight with respect to equivalent oxide content.

27. The process of claim 20, wherein the basic solution is an aqueous ammonia hydroxide solution and is approximately 4.5N.

28. The process of claim 20, wherein the calcining is conducted at a temperature of about 400° C. to 1100° C. and for about 0.25 to 24 hours.

29. The process of claim 20 any one of claims 20-28, wherein the supercritical drying is conducted at approximately 250-350° C. and approximately 130-140 bar.

30. The process of claim 20, wherein the process does not include an active comminution step.

31. (canceled)

32. (canceled)

33. The composition of claim 1, wherein the composition has a smaller particle size in comparison to a composition made by a process without oxalic acid and supercritically drying.

34. (canceled)
